(19) United States
(12) Patent Application Publication
(10) Pub. No.: US 2024/0020172 A1
(43) Pub. Date: Jan. 18, 2024

(54) PREVENTING JITTER IN HIGH PERFORMANCE COMPUTING SYSTEMS

(71) Applicant: International Business Machines Corporation, Armonk, NY (US)

(72) Inventor: Thomas GOODING, Rochester, MN (US)

(73) Assignee: International Business Machines Corporation, Armonk, NY (US)

(21) Appl. No.: 17/812,629

(22) Filed: Jul. 14, 2022

(51) Int. Cl. G06F 9/50

(52) U.S. Cl. CPC G06F 9/505

(57) ABSTRACT

A first device may obtain metrics information associated with a second device, the metrics information indicating a measurement of a performance of a component of the second device, and the metrics information being obtained via a first network. The first device may determine a load of a processing unit of the second device based on the metrics information. The first device may determine, based on the load of the processing unit, whether the second device is capable of executing a portion of a job via a second network different from the first network. The first device may cause the second device to execute the portion of the job via the second network based on determining that the second device is capable of executing the portion of the job via the second network.

### BACKGROUND

The present invention relates to high performance computing (HPC) systems, and more specifically, to prevent jitter in HPC systems.

An HPC system is typically comprised of hundreds or thousands of nodes. A job scheduler, for the HPC system, may monitor the nodes and identifying one or more nodes that may execute a job. Data associated with executing the job may be provided via a high-speed network.

In an effort to prevent overscheduling a node and/or to balance a load across a cluster of nodes, the job scheduler may determine an amount of usage (or an amount of utilization) of one or more processing units of a node, when determining whether to select the node to execute the job. In this regard, the job scheduler may monitor the amounts of usage for the nodes. For example, the job scheduler may execute a program that asynchronously polls each node for information regarding a respective amount of usage of the node. Each node may execute a daemon that provides, via the high-speed network, the information regarding the respective amount of usage of the node.

Polling the nodes in this manner disrupts the job being executed by the nodes or, in other words, causes jitter with respect to the job being executed by the nodes. The term “jitter” may refer to asynchronous activities that are not directly and immediately an action of a user. Additionally, polling the nodes in this manner can yield unreliable results when the amount of usage of a computing node approaches 100%. For example, as the amount of usage approaches 100%, the computing node is subject to delay with respect to providing a valid amount of usage of the computing node.

In the HPC system, one node may depend on data from another node in order to execute the job. Jitter may cause a delay in obtaining the data that may be used by a node to execute the job. The delay in obtaining the data may negatively affect a measure of accuracy of a result of executing the job. Additionally, as numerous nodes become subject to jitter, an anticipated time of completion of the job may be delayed. Accordingly, there is a need to enable the job scheduler to determine an amount of usage of a node without subjecting the node to jitter and without being subject to the node providing an invalid amount of usage of the node.

### SUMMARY

In some implementations, a computer-implemented method performed by a first device includes obtaining metrics information associated with a second device, the metrics information indicating a measurement of a performance of a component of the second device, and the metrics information being obtained via a first network; determining a load of a processing unit of the second device based on the metrics information; determining, based on the load of the processing unit, whether the second device is capable of executing a portion of a job via a second network different from the first network; and causing the second device to execute the portion of the job via the second network based on determining that the second device is capable of executing the portion of the job via the second network. The metrics information is obtained, by the third device and from a controller associated with the second device, via the first network. The first network is a network that is inaccessible to an operating system of the second device. An advantage of obtaining the metrics information via the first network is reducing a quantity of disruptions over the high-speed network (the disruptions resulting from the job scheduling component polling the computing node to determine the load). Therefore, an advantage of obtaining the metrics information as described herein is reducing a likelihood of the computing node being subject to jitter. An advantage of obtaining the metrics information via the network that is inaccessible to the operating system of the second device is improving a measure of security of the computing node with respect to any unauthorized access to the operating system of the computing node. Therefore, an advantage of obtaining the metrics information via the network that is inaccessible to the operating system of the second device is preventing a network attack against the computing node.

In some implementations, a computer program product for determining a load of a device includes one or more computer readable storage media, and program instructions collectively stored on the one or more computer readable storage media, the program instructions comprising: program instructions to obtain metrics information associated with the device, the metrics information indicating a measurement of a performance of a component of the device; program instructions to determine the load of the device based on the metrics information; and program instructions to cause the device to execute a portion of a job based on the load of the device. The metrics information, is obtained by a second device and from the first device, via a network that is inaccessible to an operating system of the first device. An advantage of obtaining the metrics information via the network is reducing a quantity of disruptions over the high-speed network (the disruptions resulting from the job scheduling component polling the computing node to determine the load). Therefore, an advantage of obtaining the metrics information as described herein is reducing a likelihood of the computing node being subject to jitter.

In some implementations, a system comprising: a first device configured to obtain metrics information associated with a second device, the metrics information indicating a measurement of a performance of the second device, and the metrics information being obtained via a network that is inaccessible to an operating system of the second device; and a third device configured to: obtain the metrics information from the first device; determine a load of the second device based on the metrics information; and cause the second device to execute a portion of a job based on the load of the second device. The metrics information is obtained by a second device and from the first device, via a network that is inaccessible to an operating system of the first device. An advantage of obtaining the metrics information via the network is reducing a quantity of disruptions over the high-speed network (the disruptions resulting from the job scheduling component polling the computing node to determine the load). Therefore, an advantage of obtaining the metrics information as described herein is reducing a likelihood of the computing node being subject to jitter.

In some implementations, a computer-implemented method performed by a first device includes obtaining metrics information associated with a second device, the metrics information indicating different measurements of a performance of a component of the second device during an execution of an application by the second device, and the different measurements being associated with different loads of the second device during the execution of the application by the second device; storing, in a data structure, the metrics information in association with load information indicating the different loads of the second device, the metrics information of a measurement, of the different measurements, being stored in association with a corresponding load of the different loads; obtaining particular metrics information indicating a particular measurement of the performance of the component; and causing the second device to execute a job based on a particular load, of the second device, associated with the particular measurement, the particular load being determined using the particular metrics information and the data structure. The metrics information is obtained, by a third device and from the second device, via a network that is inaccessible to an operating system of the second device. An advantage of obtaining the metrics information in this manner is reducing a quantity of disruptions over the high-speed network (the disruptions resulting from the job scheduling component polling the computing node to determine the load). Therefore, an advantage of obtaining the metrics information as described herein is reducing a likelihood of the computing node being subject to jitter.

In some implementations, a computer program product for determining a device load includes one or more computer readable storage media, and program instructions collectively stored on the one or more computer readable storage media, the program instructions comprising: program instructions to obtain metrics information associated with a device, the metrics information indicating different measurements of a performance of a component of the device during an execution of an application by the device, the different measurements corresponding to different loads of the device during the execution of the application by the device; program instructions to store, in a data structure, the metrics information in association with load information indicating the different loads of the device, the metrics information of a measurement, of the different measurements, being stored in association with a corresponding load of the different loads; program instructions to obtain particular metrics information indicating a particular measurement of the performance of the component; and program instructions to cause the device to execute a job based on a particular load, of the device, associated with the particular measurement, the particular load being determined using the particular metrics information and the data structure. The metrics information is obtained by a second device and from the first device, via a network that is inaccessible to an operating system of the first device. An advantage of obtaining the metrics information in this manner is reducing a quantity of disruptions over the high-speed network (the disruptions resulting from the job scheduling component polling the computing node to determine the load). Therefore, an advantage of obtaining the metrics information as described herein is reducing a likelihood of the computing node being subject to jitter.

### BRIEF DESCRIPTION OF THE DRAWINGS

FIGS. 1A-1F are diagrams of an example implementation described herein.

FIG. 2 is a diagram of an example environment in which systems and/or methods described herein may be implemented.

FIG. 3 is a diagram of example components of one or more devices of FIG. 2.

FIG. 4 is a flowchart of an example process relating to preventing jitter in high performance computing.

FIG. 5 is a flowchart of an example process relating to preventing jitter in high performance computing.

### DETAILED DESCRIPTION

The following detailed description of example implementations refers to the accompanying drawings. The same reference numbers in different drawings may identify the same or similar elements.

Implementations described herein are directed to using metrics information, obtained from a computing node, to determine a load of the computing node, thereby preventing the computing node from being subject to jitter. The term “load” may be used to refer to an amount of usage (or utilization) of a processing unit of the computing node (e.g., an amount of usage or utilization of a CPU and/or an amount of usage or utilization of a GPU). The term “jitter” may refer to asynchronous activities that are not directly and immediately an action of a user. Such asynchronous activities disrupt a job being executed by the computing node.

In some embodiments, the metrics information may include a measurement of a power consumption of a processing unit of the computing node (e.g., a central processing unit (CPU) and/or a graphics processing unit (GPU)). Additionally, or alternatively, the metrics information may include a measurement of a power consumption of a dynamic random access memory (DRAM) of the computing node, a measurement of a power consumption of a Peripheral Component Interconnect Express (PCIe) bus of the computing node, a measurement of a memory pressure of a memory of the computing node, a measurement of a cooling system of the computing node (e.g., a measurement of a fan speed of a fan, a measurement of a water flow rate), among other examples.

In some examples, the load of the computing node may be determined using the metrics information and a calibration data structure that stores different metrics information in association with actual load information identifying different actual loads of the computing node. For example, the calibration data structure may be used to derive the load of the computing node (e.g., derive an estimated load of the computing node).

Information identifying the load of the computing node may be stored in a metrics data structure that stores estimated load information identifying different loads (or estimated loads) of different computing nodes. A job scheduling component may access the metrics data structure to determine the load of the computing node and determine, based on the load, whether the computing node is capable of executing a job. Deriving and determining the load of the computing node as described herein prevents the job scheduling component from obtaining loads of the computing node from the computing node, especially when the load of the computing node approaches 100%.

The metrics information may be obtained via an out-of-band network instead of being obtained via the high-speed network that is used to provide data associated with executing the job. Obtaining the metrics information via the out-of-band network reduces a quantity of disruptions over the high-speed network (the disruptions resulting from the job scheduling component polling the computing node to determine the load). Therefore, an advantage of obtaining the metrics information as described herein is reducing a likelihood of the computing node being subject to jitter. Accordingly, an advantage of obtaining the metrics information and determining the load of the computing node as described herein is reducing (or eliminating) any delay associated with obtaining data used by one or more computing nodes to execute the job.

Therefore, another advantage of obtaining the metrics information and determining the load of the computing node as described herein is improving a measure of accuracy of a result of executing the job. Additionally, yet another advantage of obtaining the metrics information and determining the load of the computing node as described herein is reducing (or eliminating) any delay associated with an anticipated time of completion of the job (the delay resulting from the job scheduling component polling the computing node to determine the load).

In some embodiments, the out-of-band network may be a network that is inaccessible to an operating system of the computing node. Accordingly, an advantage of obtaining the metrics information via the out-of-band network as described herein is improving a measure of security of the computing node with respect to any unauthorized access to the operating system of the computing node. Therefore, an advantage of obtaining the metrics information via the out-of-band network as described herein is preventing a network attack against the computing node.

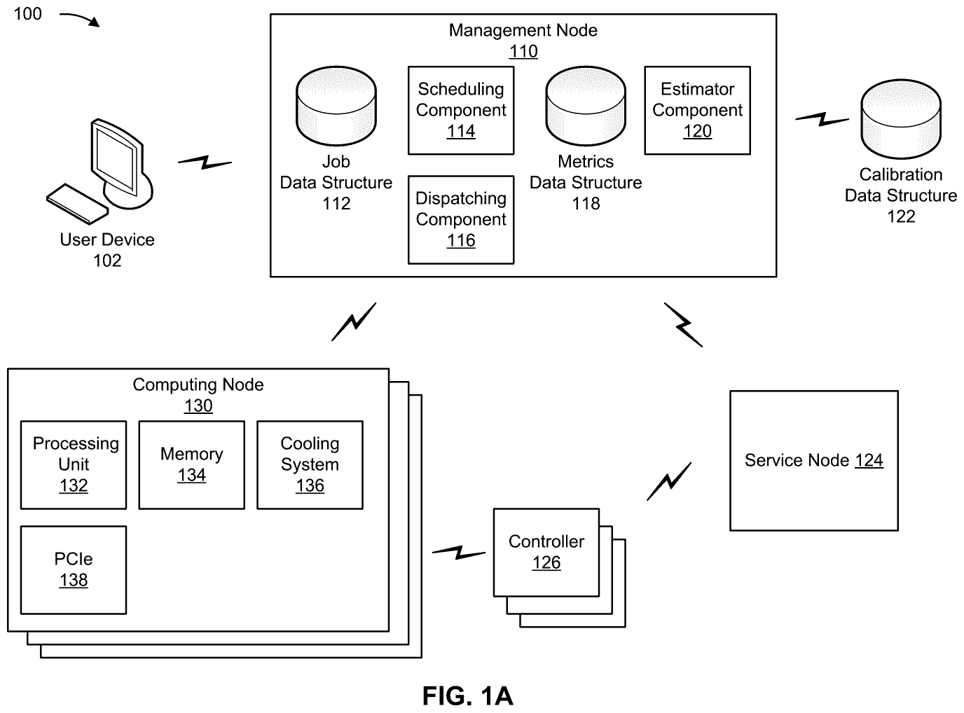

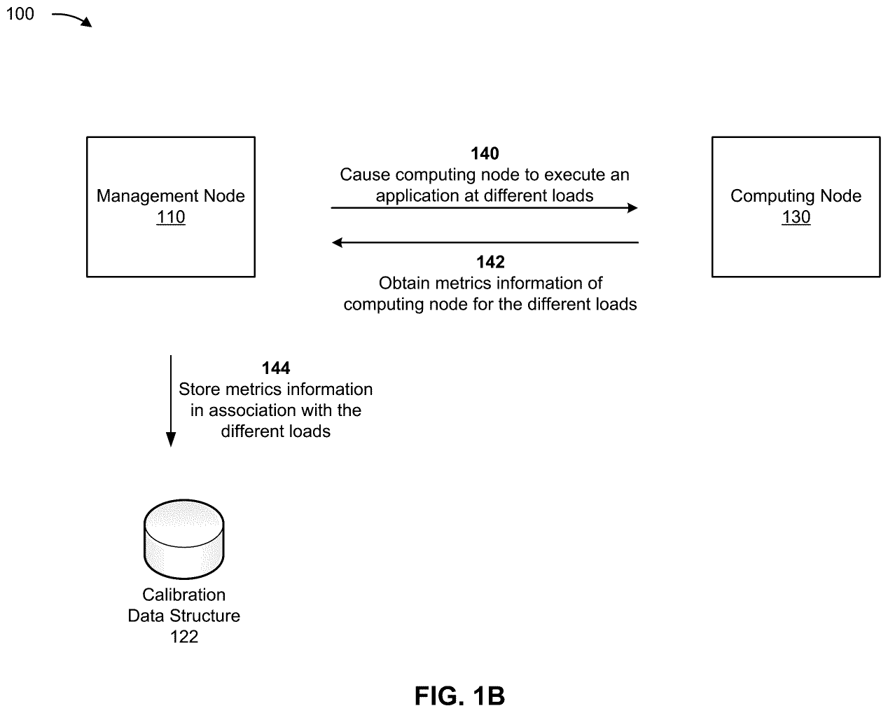

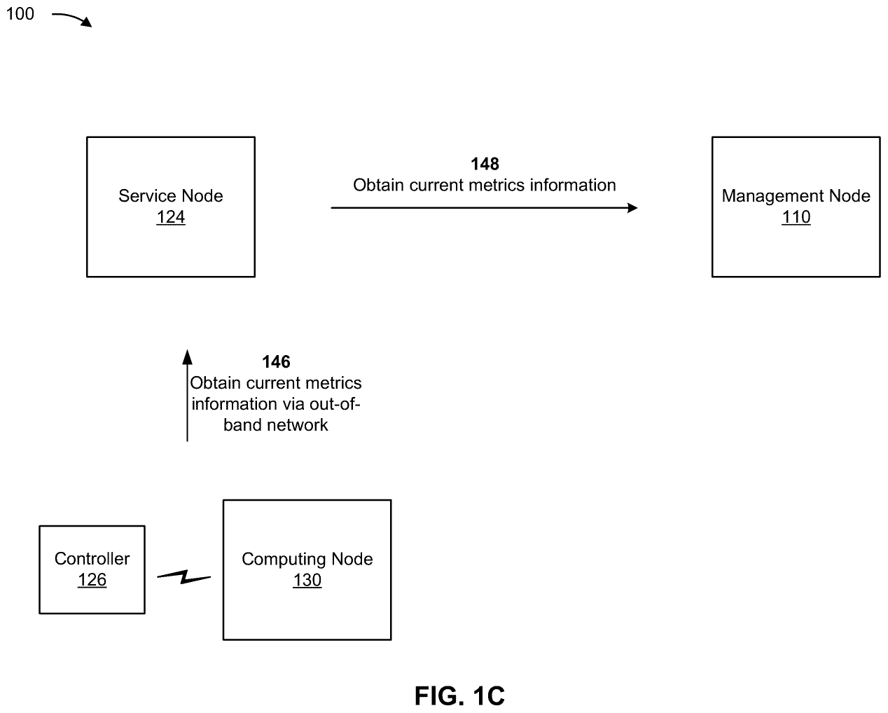

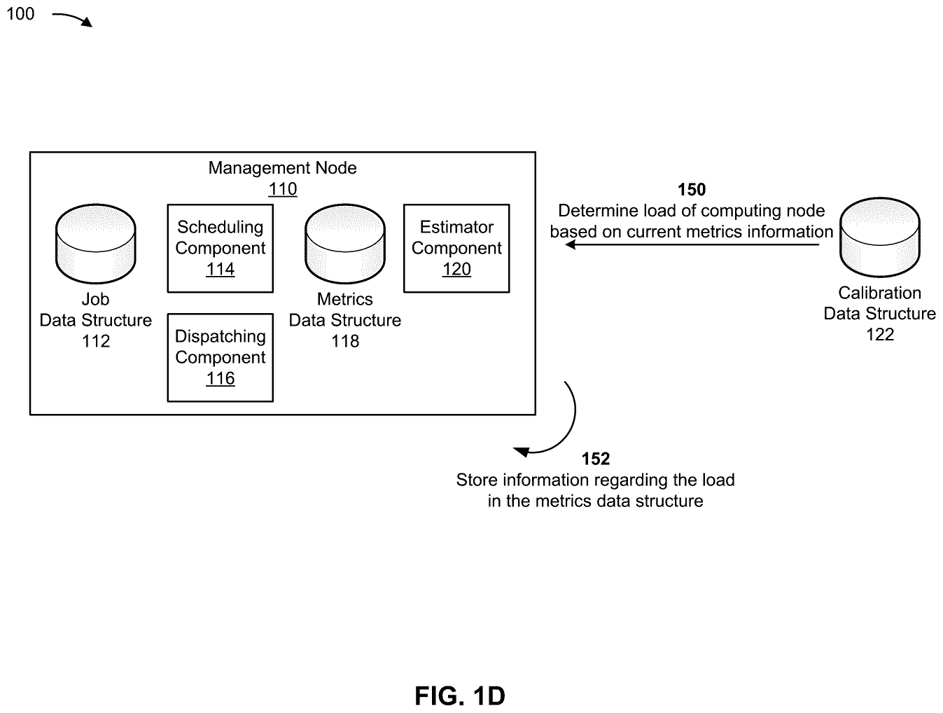

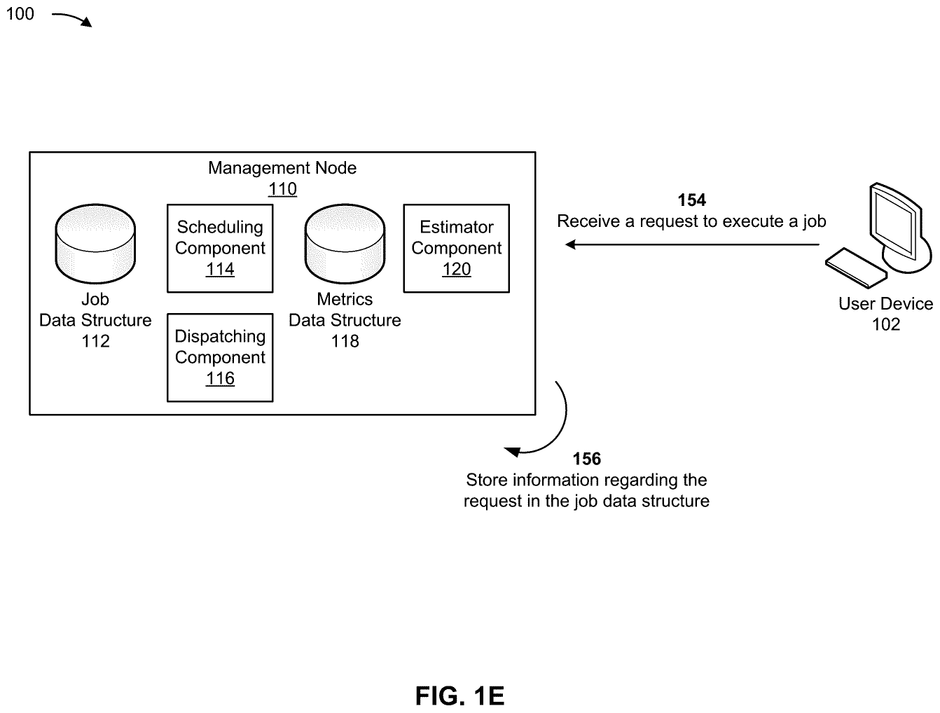

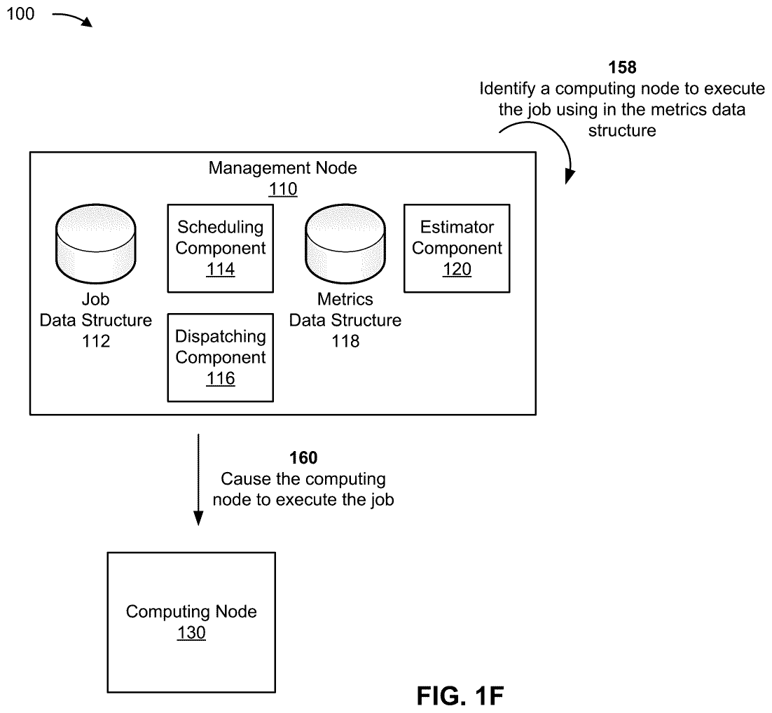

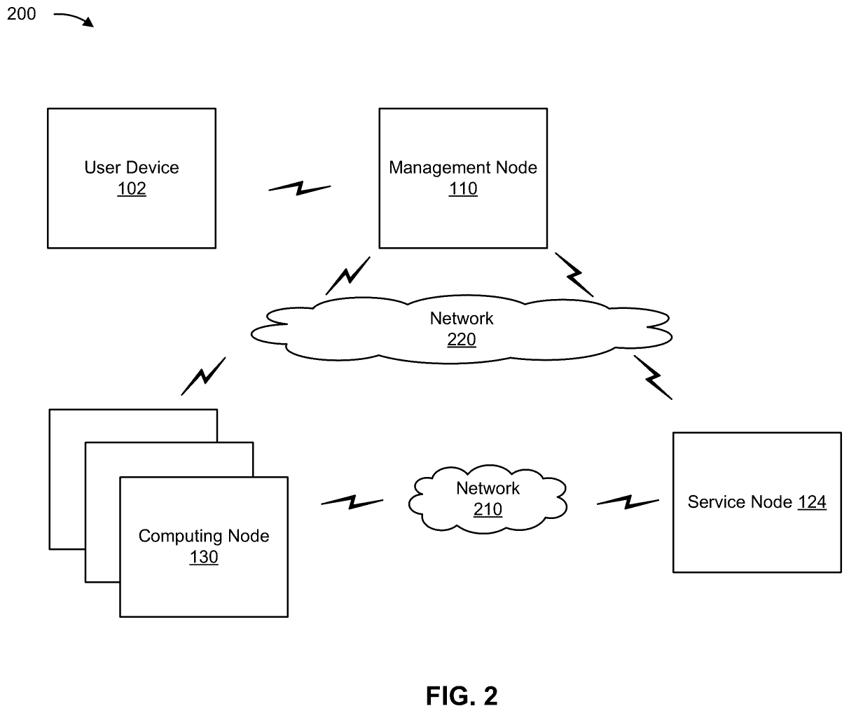

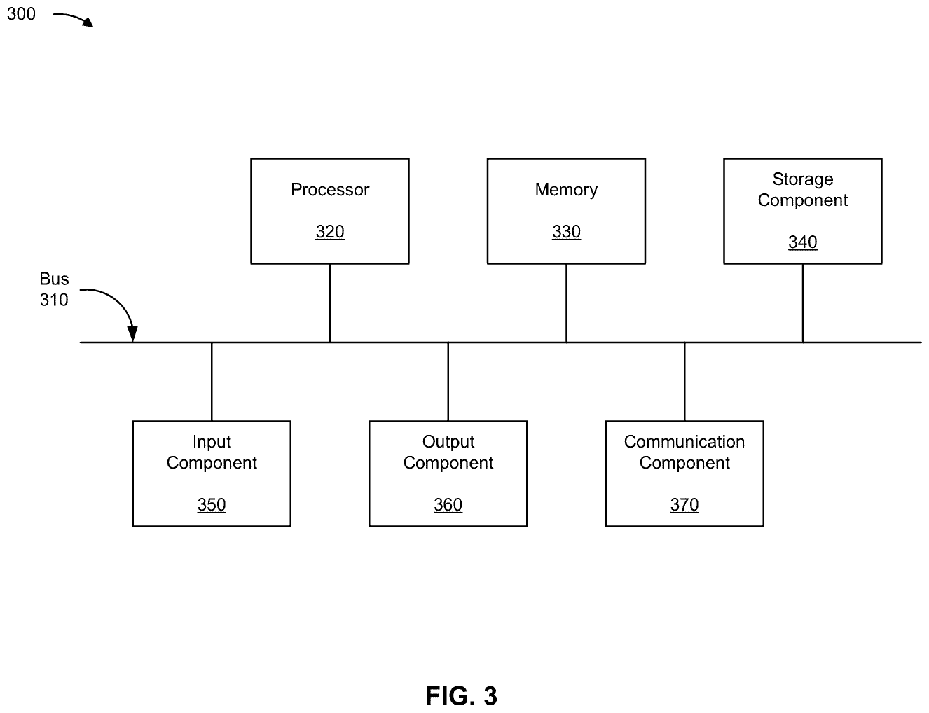

FIGS. 1A-1F are diagrams of an example implementation 100 described herein. As shown in FIGS. 1A-1F, example implementation 100 includes a user device 102, a management node 110, a calibration data structure 122, a service node 124, and a plurality of computing nodes 130 (individually “computing node 130”). These devices are described in more detail below in connection with FIG. 2 and FIG. 3.

User device 102 may include one or more devices capable of receiving, generating, storing, processing, and/or providing information regarding a job to be executed, as described elsewhere herein. User device 102 may include a communication device and a computing device. For example, user device 102 may include a wireless communication device, a mobile phone, a user equipment, a laptop computer, a tablet computer, a desktop computer, or a similar type of device.

Management node 110 may include one or more devices configured to control an operation of a cluster of computing nodes 130. For example, management node 110 may be configured to receive (e.g., from user device 102) a request to execute the job, identify one or more computing nodes 130 that are capable of executing the job, determine one or more loads of the one or more computing nodes 130, and cause the one or more computing nodes 130 to execute the job based on the one or more loads.

As shown in FIG. 1A, management node 110 may include a job data structure 112, a scheduling component 114, a dispatching component 116, a metrics data structure 118, and an estimator component 120. Job data structure 112 may include a database, a table, a queue, and/or a linked list that stores information regarding jobs that are to be executed by one or more computing nodes 130. As an example, the information regarding the job may include information regarding quantity of computing nodes 130 to execute the job, a quantity of CPUs for execution of the job, a quantity of processors for execution of the job, an amount of memory for execution of the job, and/or an estimated time of completion of the job, among other examples.

Scheduling component 114 may include one or more devices configured to identify one or more computing nodes 130 to execute the job and determine a date and a time when the one or more computing nodes 130 are to execute the job. As an example, scheduling component 114 may identify the one or more computing nodes 130 based on the information regarding the job and based on the one or more loads of the one or more computing nodes 130. For instance, scheduling component 114 may obtain information regarding the one or more loads of the one or more computing nodes 130 from metrics data structure 118.

Scheduling component 114 may provide information regarding the one or more computing nodes 130 and information regarding the job to dispatching component 116. Dispatching component 116 may include one or more devices configured to cause the one or more computing nodes 130 (identified by scheduling component 114) to execute the job.

Metrics data structure 118 may include a database, a table, a queue, and/or a linked list that stores estimated load information identifying the one or more loads (or estimated loads) of the one or more computing nodes 130. As an example, the estimated load information identifying the one or more loads may be stored in association with information regarding the one or more computing nodes 130.

The information regarding the one or more computing nodes 130 may include information identifying the one or more computing nodes (e.g., network addresses of the one or more computing nodes 130 and/or serial numbers of the one or more computing nodes, among other examples), information identifying a quantity of CPUs of the one or more computing nodes 130, information identifying a quantity of processors of the one or more computing nodes 130, and/or information identifying an amount of memory of the one or more computing nodes 130, among other examples.

For example, first estimated load information identifying a load of a first computing node 130 may be stored in association with information identifying the first computing node 130, second estimated load information identifying a load of a second computing node 130 may be stored in association with information identifying the second computing node 130, and so on. The estimated load information identifying the one or more loads may be updated by estimator component 120 (e.g., periodically and/or based on a trigger, such as a request from service node 124, from scheduling component 114, among other examples).

Estimator component 120 may include one or more devices configured to determine the one or more loads of the one or more computing nodes 130 and to store the load information identifying the one or more loads in metrics data structure 118. As an example, estimator component 120 may determine a load of a computing node 130 based on metrics information of the computing node 130. For example, estimator component 120 may perform a lookup of calibration data structure 122 using the metrics information and obtain actual load information identifying the load of the computing node 130 based on performing the lookup.

Calibration data structure 122 may include a database, a table, a queue, and/or a linked list that stores different metrics information associated with actual load information identifying different actual (or known) loads for different computing nodes 130. For example, for a computing node 130, calibration data structure 122 may store first metrics information in association with a first actual load of the computing node 130, second metrics information associated with a second actual load of the computing node 130, and so on. In some implementations, calibration data structure 122 may be external with respect to management node 110. Alternatively, calibration data structure 122 may be included in management node 110.

While job data structure 112, metrics data structure 118, and calibration data structure 122 are described herein to be different types of structures, it is understood in practice they are not limited by any particular data structure. The data in these data structures may be stored in computer registers, in a relational database as a table having a plurality of different fields and records, structured documents (e.g., extensible markup language (XML) documents), flat files, or any computer-readable format. The data may comprise any information sufficient to identify the relevant information, such as numbers, descriptive text, proprietary codes, references to data stored in other areas of a same memory or different memories (including other network locations) or information that is used by a function to calculate relevant data.

Service node 124 may include one or more devices configured to manage a cluster of computing nodes 130. As an example, service node 124 may be configured to boot up (or initialize) the computing nodes 130 of the cluster. Additionally, or alternatively, service node 124 may be configured to obtain metrics information from the computing nodes 130. Service node 124 may be configured to obtain the metrics information via an out-of-band network, instead of via the high-speed network used to provide data associated with executing the job.

Service node 124 may obtain the metrics information of a computing node 130 from a controller 126 of the computing node 130. As an example, controller 126 may include a base media controller. In some implementations, controller 126 may be external with respect to the computing node 130. Alternatively, controller 126 may be included in the computing node 130.

As shown in FIG. 1A, a computing node 130 may include a processing unit 132 (or processor), a memory 134, a cooling system 136, and a PCIe bus 138. Processing unit 132 may include a CPU and/or a GPU, among other examples. Memory 134 may include a DRAM and/or a static random access memory, among other examples. In some implementations, the cooling system 136 may include a fan, fluid-based cooling devices, among other examples. Computing node 130 may be configured to execute a portion of the job based on instructions from dispatching component 116. In some examples, computing node 130 may be configured to execute an entirety of the job.

Multiple computing nodes 130 may be included in the high-speed network. The computing nodes 130 may communicate with each other via the high-speed network. Additionally, the computing nodes 130 may communicate with management node 110 via the high-speed network.

As shown in FIG. 1B, and by reference number 140, management node 110 may cause computing node 130 to execute an application at different loads. For example, a system administrator may use management node 110 to cause computing node 130 to execute the application at different actual loads of computing node 130. In some situations, the system administrator may use a device other than management node 110 to cause computing node 130. The application may be known application.

In some examples, the application may be a type of application expected to be executed by computing node 130. For example, if computing node 130 is part of a cluster of computing nodes that typically execute jobs related to fluid dynamics applications, management node 110 may cause computing node 130 to execute a fluid dynamics application (e.g., a computational fluid dynamics application).

In some examples, the system administrator may cause computing node 130 to execute different types of applications at the different actual loads of computing node 130. As the number of different types of applications increases, a considerable cross-section of workload types may be identified for computing node 130. Accordingly, management node 110 may be able to determine metrics information for a wide range of loads associated with computing node 130 executing the different types of applications.

The different types of application may include an application of a first type involving a floating-point operation, an application of a second type involving a memory utilization, an application of a third type involving a caching operation, an application of a fourth type involving CPU utilization that exceeds GPU utilization, and/or an application of a fifth type involving GPU utilization that exceeds CPU utilization, among other examples.

As shown in FIG. 1B, and by reference number 142, management node 110 may obtain metrics information of the computing node for the different loads. For example, based on causing computing node 130 to execute the application or execute the different types of applications, management node 110 may obtain the metrics information of computing node 130 and actual load information identifying the different loads from computing node 130. The metrics information may indicate a measurement of a performance of a component of computing node 130. For example, the metrics information may indicate a power consumption of a component of computing node 130. The power consumption may be provided in watts and/or in another power measuring unit. The component may include a CPU, a GPU, a DRAM, and/or a PCIe bus such as PCIe bus 138, among examples.

By way of example, management node 110 may receive from computing node 130 first metrics information (e.g., a first power consumption of the component) when computing node 130 is idle, second metrics information (e.g., a second power consumption of the component) when the load of computing node 130 is 100%, third metrics information (e.g., a third power consumption of the component) when the load of computing node 130 is 75%, fourth metrics information (e.g., a fourth power consumption of the component) when the load of computing node 130 is 50%, and so on.

In some instances, the metrics information for the different loads of computing node 130, when executing an application of one type, may be different than the metrics information for the same loads of computing node 130 when executing an application of a different type. In some implementations, management node 110 (or the device of the system administrator) may cause computing node 130 to execute the application (or applications) for a sufficient amount of time to reach steady-state on the load and power consumption, prior to obtaining the metrics information. In some situations, the metrics information may be obtained via a network that is different than the out-of-band network. For example, the metrics may be obtained via the high-speed network.

As shown in FIG. 1B, and by reference number 144, management node 110 may store the metrics information in association with the different loads. For example, management node 110 store the metrics information and the actual load information identifying the different loads in calibration data structure 122. For example, management node 110 may store first metric information in association with first actual load information identifying a first actual load of computing node 130 (e.g., idle) when executing the application, second metric information in association with second actual load information identifying a second actual load (e.g., 100% load) of computing node 130 when executing the application, and so on.

In some situations, computing node 130 may execute different types of applications. In this regard, the metrics information may be stored in association with the actual load information identifying the different loads and information identifying the different types of applications.

While the foregoing examples have been described with respect to the metrics information indicating the power consumption of the component of computing node 130, the metrics information may additionally, or alternatively, indicate a measurement of a memory pressure of a memory of computing node 130, a measurement of a cooling system of computing node 130, a number of instructions per second (or hardware count), and/or an indication of a power management mode of computing node 130, among other examples.

The measurement of the cooling system of computing node 130 may include a measurement of a fan speed of a fan, a measurement of a water flow rate, a measurement of a water pressure, an inlet temperature, and/or an outlet temperature, among other examples. The instructions may include interrupts, instructions relating to floating-points, and/or wait instructions, among other examples. The power management mode may include a normal mode, a sleep mode, and/or a performance mode, among other examples.

As shown in FIG. 1C, and by reference number 146, service node 124 may obtain current metrics information via an out-of-band network. For example, after the metrics information and the actual load information have been stored in calibration data structure 122, service node 124 may obtain the current metrics information from computing node 130. In some examples, service node 124 may obtain the current metrics information based on a network request (e.g., a request from management node 110 and/or a request from a device of the system administrator, among other examples). Additionally, or alternatively, service node 124 may obtain the current metrics information periodically (e.g., every ten seconds, every fifteen seconds, every twenty seconds, among other examples). As frequency of service node 124 obtaining the current metrics information increases, a fidelity (or a measure of trustworthiness) of the load of computing node 130 determined by management node 110 increases.

Service node 124 may obtain the current metrics information from controller 126 associated with computing node 130. By obtaining the current metrics information from controller 126 via the out-of-band network, service node 124 may minimize disruptions on the high-speed network that is used by computing node 130 to provide data associated with jobs executed by computing node 130, thereby reducing or eliminating jitter.

As shown in FIG. 1C, and by reference number 148, management node 110 may obtain the current metrics information from service node 124. For example, after obtaining the current metrics information, service node 124 may provide the current metrics information to management node 110.

As shown in FIG. 1D, and by reference number 150, management node 110 may determine the load of the computing node based on the current metrics information. For example, after receiving the current metrics information from service node 124, management node 110 (e.g., using estimator component 120) may use the current metrics information to determine the load of computing node 130. In some examples, computing node 130 may perform a lookup of calibration data structure 122 using the current metrics information. Based on performing the lookup, management node 110 may obtain actual load information corresponding to the current metrics information and may determine the load of computing node 130 as the actual load identified by the actual load information.

In some instances, management node 110 further use information identifying a type of application in addition to the current metrics information to perform the lookup. In some situations, in the event the metrics information does not match metrics information included in calibration data structure 122, estimator component 120 may obtain loads for a range of power consumptions that includes the power consumption and determine the load of computing node 130 based on the loads (e.g., based on an average of the loads).

Additionally, or alternatively, to performing the lookup, management node 110 determine the load of computing node 130 using a machine learning model trained to predict loads of different computing node 130 based on metric information. The machine learning model may be trained based on historical data regarding different loads and historical metrics information associated with the different loads. In this regard, management node 110 may provide the current metrics information as an input to the machine learning model and the machine learning model may provide, as an output, information regarding the load of computing node 130.

As shown in FIG. 1D, and by reference number 152, management node 110 may store information regarding the load in metrics data structure 118. For example, after determining the load of computing node 130, management node 110 (e.g., using estimator component 120) may store estimated load information identifying the load of computing node 130 in metrics data structure 118. Management node 110 may store the estimated load information in association with the information identifying computing node 130. In some examples, the estimated load information may include raw metrics information obtained by service node 124 via the out-of-band network.

As shown in FIG. 1E, and by reference number 154, management node 110 may receive a request to execute a job. For example, management node 110 may receive the request from user device 102 after management node 110 stores the estimated load information in metrics data structure 118. Alternatively, management node 110 may receive the request after management node 110 determines the load of computing node 130 but prior to storing the estimated load information in metrics data structure 118. Alternatively, management node 110 may receive the request prior to service node 124 obtaining the current metrics information.

The request may include information regarding the job. The information regarding the job may include information regarding a quantity of computing nodes 130 to execute the job, a quantity of CPUs for execution of the job, a quantity of processors for execution of the job, an amount of memory for execution of the job, and/or an estimated time of completion of the job, among other examples.

As shown in FIG. 1E, and by reference number 156, management node 110 may store information regarding the request in the job data structure. For example, management node 110 may store information identifying the request (e.g., an identifier of the request) in association with the information regarding the job.

As shown in FIG. 1F, and by reference number 158, management node 110 may identify a computing node to execute the job using the metrics data structure. For example, management node 110 (e.g., using scheduling component 114) may obtain the information regarding the job from job data structure 112 and may use the information regarding the job as search criteria to search metrics data structure 118 to identify one or more computing node 130 that are capable of executing the job or capable of executing the job.

Management node 110 (e.g., using scheduling component 114) may identify computing node 130 and may determine whether the load of computing node 130 (identified by the estimated load information of computing node 130) enables computing node 130 to execute the job. For example, management node 110 may determine whether the load of computing node 130 satisfies a load threshold. If management node 110 determines that the load of computing node 130 satisfies the load threshold, management node 110 may determine that computing node 130 is not capable of executing the job at this time.

In some situations, scheduling component 114 may include a version of metrics data structure 118 (e.g., a copy of metrics data structure 118). In this regard, scheduling component 114 may identify computing node 130 using the version of metrics data structure 118 (instead using metrics data structure 118). Scheduling component 114 may be configured to update the version of metrics data structure 118 such that the version of metrics data structure 118 is up-to-date with respect to metrics data structure 118.

As shown in FIG. 1F, and by reference number 160, management node 110 may cause the computing node to execute the job. For example, management node 110 (e.g., using scheduling component 114) may determine that the load of computing node 130 does not satisfy the load threshold. Based on determining that the load of computing node 130 does not satisfy the load threshold, scheduling component 114 may provide to dispatching component 116 execution information indicating computing node 130 is to execute a portion of the job. The information may include the information regarding the job, the information identifying computing node 130, and/or information indicating a time when computing node 130 is to start executing the job, among other examples. Based on receiving the execution information, dispatching component 116 may provide to computing node 130 instructions to cause computing node 130 to execute a portion of the job. The instructions may include the information regarding the job. Computing node 130 may receive the instructions via a network that is different than the out-of-band network. For example, computing node 130 may receive the instructions via the high-speed network.

Metric information discussed herein may be associated with a hardware type (e.g., power consumption, hardware performance counters, among other examples). The metrics information (e.g., power consumption, hardware performance counters) may bundled and passed through a conversion step to convert the metrics information to the load of computing node 130. For example, the conversion step may take the metrics information and derive an estimate of the load of computing node 130. The estimated load of computing node 130 may be stored in metrics data structure 118. Scheduling component 114 may then be able to asynchronously access the load of computing node 130 and schedule executions of different jobs. The example described herein would not involve direct measurement of computing node 130, thereby avoiding introducing jitter to applications or activity on the high-speed network associated with computing node 130.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions 2022 by utilizing state information of the computer readable program instructions to personalize the electronic circuitry, in order to perform aspects of the present invention.

As indicated above, FIGS. 1A-1F are provided as an example. Other examples may differ from what is described with regard to FIGS. 1A-1F. The number and arrangement of devices shown in FIGS. 1A-1F are provided as an example. A network, formed by the devices shown in FIGS. 1A-1F may be part of a network that comprises various configurations and uses various protocols including local Ethernet networks, private networks using communication protocols proprietary to one or more companies, cellular and wireless networks (e.g., Wi-Fi), instant messaging, hypertext transfer protocol (HTTP) and simple mail transfer protocol (SMTP, and various combinations of the foregoing.

There may be additional devices (e.g., a large number of devices), fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram of an example environment 200 in which systems and/or methods described herein can be implemented. As shown in FIG. 2, environment 200 may include user device 102, management node 110, service node 124, and a plurality of computing nodes 130. User device 102, management node 110, service node 124, and computing nodes 130 have been described above in connection with FIG. 1. Devices of environment 200 can interconnect via wired connections, wireless connections, or a combination of wired and wireless connections.

Management node 110 may include a communication device and a computing device. For example, management node 110 includes computing hardware used in a cloud computing environment. In some examples, management node 110 may include a server, such as an application server, a client server, a web server, a database server, a host server, a proxy server, a virtual server (e.g., executing on computing hardware), or a server in a cloud computing system.

Service node 124 may include a communication device and a computing device. For example, service node 124 includes computing hardware used in a cloud computing environment. In some examples, service node 124 may include a server, such as an application server, a client server, a web server, a database server, a host server, a proxy server, a virtual server (e.g., executing on computing hardware), or a server in a cloud computing system.

Computing node 130 may include a communication device and a computing device. For example, computing node 130 includes computing hardware used in a cloud computing environment. In some examples, computing node 130 may include a server, such as an application server, a client server, a web server, a database server, a host server, a proxy server, a virtual server (e.g., executing on computing hardware), or a server in a cloud computing system.

Network 210 includes one or more wired and/or wireless networks. For example, network 210 may include Ethernet switches. Additionally, or alternatively, network 210 may include a cellular network, a public land mobile network (PLMN), a local area network (LAN), a wide area network (WAN), a private network, the Internet, and/or a combination of these or other types of networks. Network 210 enables communication between service node 124 and computing node 130. For example, network 210 may be the out-of-band network.

Network 220 includes one or more wired and/or wireless networks. For example, network 220 may include a cellular network, a public land mobile network (PLMN), a local area network (LAN), a wide area network (WAN), a private network, the Internet, and/or a combination of these or other types of networks. Network 220 enables communication among the devices of environment 200, as shown in FIG. 2. For example, network 220 may the high-speed network.

The number and arrangement of devices and networks shown in FIG. 2 are provided as an example. In practice, there can be additional devices and/or networks, fewer devices and/or networks, different devices and/or networks, or differently arranged devices and/or networks than those shown in FIG. 2. Furthermore, two or more devices shown in FIG. 2 can be implemented within a single device, or a single device shown in FIG. 2 can be implemented as multiple, distributed devices. Additionally, or alternatively, a set of devices (e.g., one or more devices) of environment 200 can perform one or more functions described as being performed by another set of devices of environment 200.

FIG. 3 is a diagram of example components of a device 300, which may correspond to management node 110, service node 124, and/or computing node 130. In some implementations, management node 110, service node 124, and/or computing node 130 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

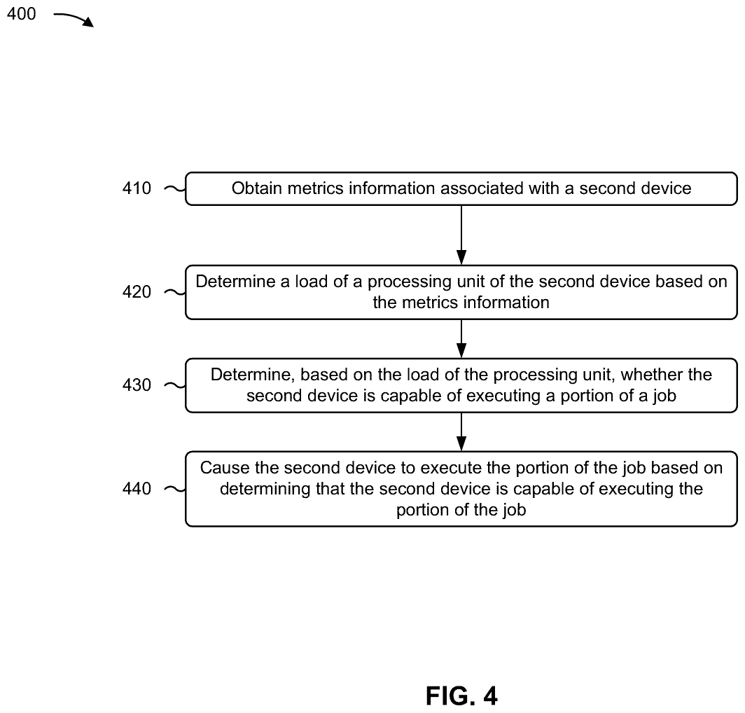

FIG. 4 is a flowchart of an example process 400 associated with preventing jitter in high performance computing. In some implementations, one or more process blocks of FIG. 4 may be performed by a first device (e.g., management node 110). In some implementations, one or more process blocks of FIG. 4 may be performed by another device or a group of devices separate from or including the first device, such as a user device (e.g., user device 102), a service node (e.g., service node 124), and/or a computing node (e.g., computing node 130). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include obtaining metrics information associated with a second device, the metrics information indicating a measurement of a performance of a component of the second device, the metrics information being obtained via a first network (block 410). For example, the first device may obtain metrics information associated with a second device, the metrics information indicating a measurement of a performance of a component of the second device, the metrics information being obtained via a first network, as described above.

As further shown in FIG. 4, process 400 may include determining a load of a processing unit of the second device based on the metrics information (block 420). For example, the first device may determine a load of a processing unit of the second device based on the metrics information, as described above.

As further shown in FIG. 4, process 400 may include determining, based on the load of the processing unit, whether the second device is capable of executing a portion of a job via a second network different from the first network (block 430). For example, the first device may determine, based on the load of the processing unit, whether the second device is capable of executing a portion of a job via a second network different from the first network, as described above.

As further shown in FIG. 4, process 400 may include causing the second device to execute the portion of the job via the second network based on determining that the second device is capable of executing the portion of the job via the second network (block 440). For example, the first device may cause the second device to execute the portion of the job via the second network based on determining that the second device is capable of executing the portion of the job via the second network, as described above.

Process 400 may include additional implementations, such as any single implementation or any combination of implementations described below and/or in connection with one or more other processes described elsewhere herein.

In some implementations, the load of the processing unit includes an amount of usage of the processing unit, and wherein determining the load comprises using a machine learning model to predict the load based on the metrics information indicating the measurement.

In some implementations, obtaining the metrics information comprises obtaining the metrics information from a third device. The metrics information is obtained, by the third device and from a controller associated with the second device, via the first network. The first network is a network that is inaccessible to an operating system of the second device.

In some implementations, the component includes the processing unit, wherein the measurement of the performance of the component of the second device includes a measurement of a power consumption of the processing unit, and wherein determining the load of the processing unit based on the metrics information comprises determining the load of the processing unit based on the measurement of the power consumption of the processing unit.

In some implementations, the component includes a dynamic random-access memory, wherein the measurement of the performance of the component of the second device includes a measurement of a power consumption of the dynamic random-access memory, and wherein determining the load of the processing unit based on the metrics information comprises determining the load of the processing unit based on the measurement of the power consumption of the dynamic random-access memory.

In some implementations, determining the load comprises obtaining, from a data structure and using the metrics information, information indicating the load of the second device associated with the measurement. The data structure stores load information, indicating different loads of the processing unit, in association with metrics information indicating different measurements of a performance of the component. The different measurements correspond to the different loads. The load information, indicating each load of the different loads, is stored in association with the metrics information indicating a corresponding measurement of the different measurements.

In some implementations, the different loads are associated with the second device executing an application. The different measurements are obtained during execution of the application by the second device.

In some implementations, the load of the processing unit includes an amount of usage of the processing unit. Determining the load comprises using a machine learning model to predict the load based on the metrics information indicating the measurement.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

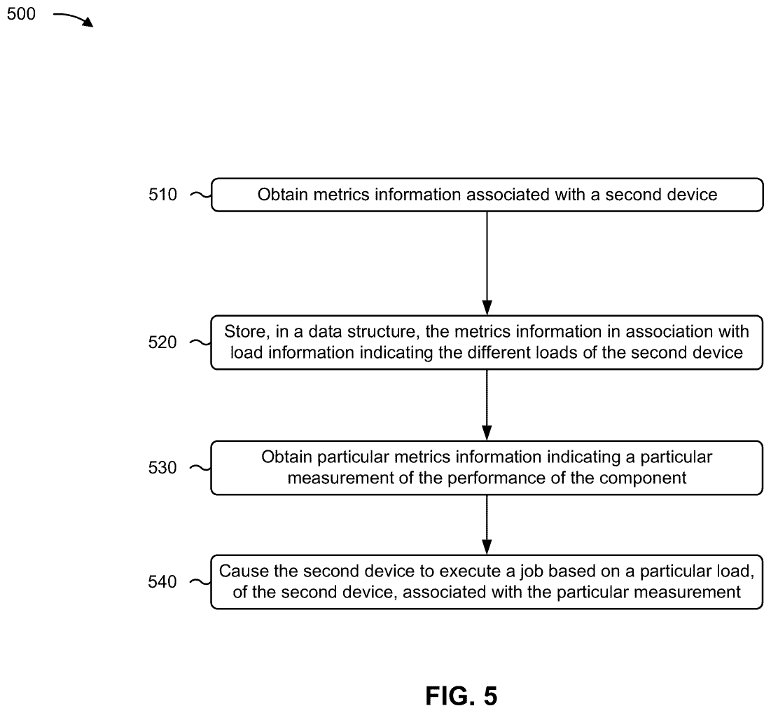

FIG. 5 is a flowchart of an example process 500 associated with preventing jitter. In some implementations, one or more process blocks of FIG. 5 may be performed by a first device (e.g., management node 110). In some implementations, one or more process blocks of FIG. 4 may be performed by another device or a group of devices separate from or including the first device, such as a user device (e.g., user device 102), a service node (e.g., service node 124), and/or a computing node (e.g., computing node 130). Additionally, or alternatively, one or more process blocks of FIG. 5 may be performed by one or more components of device 300, such as processor 320, memory 330, storage component 340, input component 350, output component 360, and/or communication component 370.

As shown in FIG. 5, process 500 may include obtaining metrics information associated with a second device, metrics information indicating different measurements of a performance of a component of the second device during an execution of an application by the second device, and the different measurements being associated with different loads of the second device during the execution of the application by the second device (block 510). For example, the first device may obtain metrics information associated with a second device, metrics information indicating different measurements of a performance of a component of the second device during an execution of an application by the second device, and the different measurements being associated with different loads of the second device during the execution of the application by the second device, as described above.

As further shown in FIG. 5, process 500 may include storing, in a data structure, the metrics information in association with load information indicating the different loads of the second device, the metrics information of a measurement, of the different measurements, is being stored in association with a corresponding load of the different loads (block 520). For example, the first device may store, in a data structure, the metrics information in association with load information indicating the different loads of the second device, the metrics information of a measurement, of the different measurements, is being stored in association with a corresponding load of the different loads, as described above.

As further shown in FIG. 5, process 500 may include obtaining particular metrics information indicating a particular measurement of the performance of the component (block 530). For example, the first device may obtain particular metrics information indicating a particular measurement of the performance of the component, as described above.

As further shown in FIG. 5, process 500 may include causing the second device to execute a job based on a particular load, of the second device, associated with the particular measurement, the particular load being determined using the particular metrics information and the data structure (block 540). For example, the first device may cause the second device to execute a job based on a particular load, of the second device, associated with the particular measurement, the particular load being determined using the particular metrics information and the data structure, as described above.

Process 500 may include additional implementations, such as any single implementation or any combination of implementations described below and/or in connection with one or more other processes described elsewhere herein.

In some implementations, obtaining the particular metrics information comprises obtaining the particular metrics information via a network that is inaccessible to an operating system of the second device.

In some implementations, the component includes a processing unit, wherein the measurement of the performance of the component of the second device includes a measurement of a power consumption of the processing unit, wherein the particular load includes a load of the processing unit, and wherein the method further comprises determining the load of the processing unit based on the measurement of the power consumption of the processing unit.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method performed by a first device, the method comprising:
obtaining metrics information associated with a second device,
the metrics information indicating a measurement of a performance of a component of the second device, and
the metrics information being obtained via a first network;
determining a load of a processing unit of the second device based on the metrics information;
determining, based on the load of the processing unit, whether the second device is capable of executing a portion of a job via a second network different from the first network; and
causing the second device to execute the portion of the job via the second network based on determining that the second device is capable of executing the portion of the job via the second network.

2. The computer-implemented method of claim 1, wherein determining the load comprises:
obtaining, from a data structure and using the metrics information, information indicating the load of the second device associated with the measurement,
wherein the data structure stores load information, indicating different loads of the processing unit, in association with metrics information indicating different measurements of a performance of the component,
wherein the different measurements correspond to the different loads, and
wherein the load information, indicating each load of the different loads, is stored in association with the metrics information indicating a corresponding measurement of the different measurements.

3. The computer-implemented method of claim 2, wherein the different loads are associated with the second device executing one or more applications, and
wherein the different measurements are obtained during execution of the one or more applications by the second device.

4. The computer-implemented method of claim 1, wherein the load of the processing unit includes an amount of usage of the processing unit, and
wherein determining the load comprises:
using a machine learning model to predict the load based on the metrics information indicating the measurement.

5. The computer-implemented method of claim 1, wherein obtaining the metrics information comprises:
obtaining the metrics information from a third device,
wherein the metrics information is obtained, from the third device and from a controller associated with the second device, via the first network, and
wherein the first network is a network that is inaccessible to an operating system of the second device.

6. The computer-implemented method of claim 1, wherein the component includes the processing unit,
wherein the measurement of the performance of the component of the second device includes a measurement of a power consumption of the processing unit, and
wherein determining the load of the processing unit based on the metrics information comprises:
determining the load of the processing unit based on the measurement of the power consumption of the processing unit.

7. The computer-implemented method of claim 1, wherein the component includes a dynamic random access memory,
wherein the measurement of the performance of the component of the second device includes a measurement of a power consumption of the dynamic random access memory, and
wherein determining the load of the processing unit based on the metrics information comprises:
determining the load of the processing unit based on the measurement of the power consumption of the dynamic random access memory.

8. A computer program product for determining a load of a device, the computer program product comprising:
one or more computer readable storage media, and program instructions collectively stored on the one or more computer readable storage media, the program instructions comprising:
program instructions to obtain metrics information associated with the device,
the metrics information indicating a measurement of a performance of a component of the device;
program instructions to determine the load of the device based on the metrics information; and
program instructions to cause the device to execute a portion of a job based on the load of the device.

9. The computer program product of claim 8, wherein the program instructions to determine the load of the device based on the metrics information comprises:
program instructions to determine a memory pressure of a memory associated with a processing unit of the device based on the measurement of the performance of the component of the device.

10. The computer program product of claim 8, wherein the device is a first device, and wherein the program instructions to obtain the metrics information include:
program instructions to obtain the metrics information from a second device,
wherein the metrics information, is obtained from the second device and by the first device, via a network that is inaccessible to an operating system of the first device.

11. The computer program product of claim 8, wherein the program instructions to determine the load of the device include:
program instructions to obtain, from a data structure and using the metrics information, load information indicating the load of the device,
wherein the metrics information is stored, in the data structure, in association with the load information, and
wherein the load information indicates the load of the device.

12. The computer program product of claim 8, wherein the component includes a Peripheral Component Interconnect Express (PCIe) bus,
wherein the measurement of the performance of the component includes a measurement of a power consumption of the PCIe bus, and
wherein the program instructions to determine the load of the device based on the metrics information comprises:
program instructions to determine a load of a processing unit of the device based on the measurement of the power consumption of the PCIe bus.

13. The computer program product of claim 8, wherein the component includes a cooling system of the device,
wherein the measurement of the performance of the component includes a measurement of a performance of the cooling system, and
wherein the program instructions to determine the load of the device based on the metrics information comprises:
program instructions to determine a load of a processing unit of the device based on the measurement of the performance of the cooling system.

14. The computer program product of claim 8, wherein the component includes a fan of the device,
wherein the measurement of the performance of the component includes a measurement of a fan speed of the fan, and
wherein the program instructions to determine the load of the device based on the metrics information comprises:
program instructions to determine a load of a processing unit of the device based on the fan speed.

15. A system comprising:
a first device configured to obtain metrics information associated with a second device,
the metrics information indicating a measurement of a performance of the second device, and
the metrics information being obtained via a network that is inaccessible to an operating system of the second device; and
a third device configured to:
obtain the metrics information from the first device;
determine a load of the second device based on the metrics information; and
cause the second device to execute a portion of a job based on the load of the second device.

16. The system of claim 15, wherein the measurement of the performance of the second device includes a power management mode of the second device, and
wherein the third device, to determine the load of the second device, is configured to:
determine the load of the second device based on the power management mode of the second device.

17. The system of claim 15, wherein the measurement of the performance of the second device includes a number of instructions per a period of time, and
wherein the third device, to determine the load of the second device, is configured to:
determine the load of the second device based on the number of instructions per the period of time.

18. The system of claim 17, wherein the third device, to determine the load of the second device, is configured to:
determine a memory pressure of a memory associated with a processing unit of the second device based on the number of instructions per the period of time.

19. The system of claim 15, wherein the third device, to determine the load of the second device, is configured to:
provide the metrics information as an input to a machine learning model; and
determine the load of the second device based on an output of the machine learning model.

20. The system of claim 15, wherein the measurement of the performance of the second device includes a measurement of a power consumption of a processing unit of the second device, and
wherein the third device, to determine the load of the second device, is configured to:
determine the load of the processing unit based on the measurement of the power consumption of the processing unit.

21. A computer-implemented method performed by a first device, the method comprising:
obtaining metrics information associated with a second device,
the metrics information indicating different measurements of a performance of a component of the second device during an execution of an application by the second device, and
the different measurements being associated with different loads of the second device during the execution of the application by the second device;
storing, in a data structure, the metrics information in association with load information indicating the different loads of the second device,
the metrics information of a measurement, of the different measurements, being stored in association with a corresponding load of the different loads;
obtaining particular metrics information indicating a particular measurement of the performance of the component; and
causing the second device to execute a job based on a particular load, of the second device, associated with the particular measurement,
the particular load being determined using the particular metrics information and the data structure.

22. The computer-implemented method of claim 21, wherein obtaining the metrics information comprises:
obtaining the metrics information from a third device,
wherein the metrics information is obtained, from the third device and from the second device, via a network that is inaccessible to an operating system of the second device.

23. The computer-implemented method of claim 21, wherein the component includes a processing unit,
wherein the measurement of the performance of the component of the second device includes a measurement of a power consumption of the processing unit,
wherein the particular load includes a load of the processing unit, and
wherein the method further comprises:
determining the load of the processing unit based on the measurement of the power consumption of the processing unit.

24. A computer program product for determining a device load, the computer program product comprising:
one or more computer readable storage media, and program instructions collectively stored on the one or more computer readable storage media, the program instructions comprising:
program instructions to obtain metrics information associated with a device,
the metrics information indicating different measurements of a performance of a component of the device during an execution of an application by the device,
the different measurements corresponding to different loads of the device during the execution of the application by the device;
program instructions to store, in a data structure, the metrics information in association with load information indicating the different loads of the device,
the metrics information of a measurement, of the different measurements, being stored in association with a corresponding load of the different loads;
program instructions to obtain particular metrics information indicating a particular measurement of the performance of the component; and
program instructions to cause the device to execute a job based on a particular load, of the device, associated with the particular measurement,
the particular load being determined using the particular metrics information and the data structure.

25. The computer program product of claim 24, wherein the device is a first device, and wherein the program instructions to obtain the metrics information include:
program instructions to obtain the metrics information from a second device,
wherein the metrics information, is obtained from the second device and by the first device, via a network that is inaccessible to an operating system of the first device.
